(19) United States
(12) Patent Application Publication
(10) Pub. No.: US 2024/0118184 A1
(43) Pub. Date: Apr. 11, 2024

(54) PARTICLE SENSOR

(71) Applicant: Robert Bosch GmbH, Stuttgart (DE)

(72) Inventors: Carlos Arturo Robles Collantes, Stuttgart (DE); Christopher Holzknecht, Stuttgart (DE); Enno Baars, Leonberg (DE); Moritz Humbert, Korntal-Muenchingen (DE); Sven Schuette, Leonberg (DE)

(21) Appl. No.: 18/468,357

(22) Filed: Sep. 15, 2023

(30) Foreign Application Priority Data
Oct. 7, 2022 (DE) 10 2022 210 609.1

(51) Int. Cl. G01N 15/06; F02D 41/14

(52) U.S. Cl. CPC G01N 15/0656; F02D 41/1466; G01N 2015/0046

(57) ABSTRACT

A particle sensor for determining the concentration of soot in the exhaust gas of an internal combustion engine. The particle sensor includes a sleeve-shaped sensor housing, a sensor element fixed in the sensor housing and projecting beyond the sensor housing on the exhaust gas side, and a sleeve-shaped protection tube fastened to the sensor housing on the exhaust gas side, the protection tube including an inner protection sleeve and an outer protection sleeve, the inner protection sleeve surrounding an exhaust-gas-side end region of the sensor element, the outer protection sleeve surrounding the inner protection sleeve at least in some regions, so that an annular space is formed between the outer protection sleeve and inner protection sleeve. The outer protection sleeve and the inner protection sleeve each have a gas outlet and a gas inlet.

### CROSS REFERENCE

The present application claims the benefit under 35 U.S.C. § 119 of German Patent Application No. DE 10 2022 210 609.1 filed on Oct. 7, 2022, which is expressly incorporated herein by reference in its entirety.

### BACKGROUND INFORMATION

German Patent Application No. DE 10 2017 206 308 A1 describes a particle sensor comprising a sleeve-shaped sensor housing, a sensor element fixed in the sensor housing, which sensor element projects beyond the sensor housing on the exhaust gas side, and a sleeve-shaped protection tube, which is fastened to the sensor housing on the exhaust gas side, the protection tube consisting of an inner protection sleeve and an outer protection sleeve, the inner protection sleeve surrounding an exhaust-gas-side end region of the sensor element, the outer protection sleeve surrounding the inner protection sleeve at least in some regions, so that an annular space is formed between the outer protection sleeve and inner protection sleeve, the outer protection sleeve and the inner protection sleeve each having a gas outlet and a gas inlet, and a flow occurring through the protection tube from the gas inlet of the outer protection sleeve into the annular space, from there through the gas inlet of the inner protection sleeve into the interior of the inner protection sleeve and from there through the gas outlets of the outer and inner protection sleeves. The gas inlet of the inner protection sleeve forms the smallest flow cross section when flow is present through the protection tube.

### SUMMARY

Particle sensors within the meaning of the present invention serve to detect the concentration of solid components of a gas, for example the concentration of soot in an exhaust gas of an internal combustion engine.

The present invention is based on the desire to increase the sensitivity of the particle sensor.

It is provided according to an example embodiment of the present invention that the gas inlet of the inner protection sleeve consists of a plurality of gas inlet openings that are arranged on at least two rings of holes spaced apart from each other in the longitudinal direction and extending in the circumferential direction, each gas inlet opening individually being associated with a deflection element that deflects an exhaust gas, which enters the annular space through the relevant gas inlet opening, in the direction of the gas outlet of the inner protection sleeve.

The provision of the deflection elements, which deflect an exhaust gas, which enters the annular space, in the direction of the gas outlet of the inner protection sleeve, has the technical effect that the exhaust gas reaches the sensor element with an inherently undiminished velocity, but with a reduced normal velocity component. Investigations by the inventors showed that the reliability of the sensor operation could be improved in this configuration. With regard to particle sensors, this is due inter alia to the fact that, under certain operating conditions, a reduced normal velocity component prevents soot particles and soot particle structures, for example soot bridges between interdigitated electrodes, that have already adhered to the sensor element from being becoming detached again and thus no longer being available for measurement.

For example, according to an example embodiment of the present invention, two rings of holes spaced apart from each other in the longitudinal direction and extending in the circumferential direction can be provided, for example with eight gas inlet openings arranged equidistantly from each other in the circumferential direction (i.e., in the example, at 450 relative to each other).

These two rings of holes can furthermore be individualized by the designations “first ring of holes” and “second ring of holes.” It can then be provided that the gas inlet openings of the first ring of holes are arranged centrally between the gas inlet openings of the second ring of holes, as seen in the circumferential direction.

According to an example embodiment of the present invention, a distance in the longitudinal direction between the two rings of holes can be, for example, 3 mm to 6 mm.

It can be provided that a total length of the protection tube is not more than 21 mm. In this way, its manufacturability is simplified.

Overall, the sensitivity of a particle sensor can in particular be increased by the present invention.

According to the present invention, the particle sensor has a sleeve-shaped sensor housing, which in particular has a through-hole and in this respect in particular defines an axis or longitudinal axis and an axial direction within the scope of the present invention. In particular, in the context of the present invention, an orientation of this axis or this axial direction is referred to as on the exhaust gas side.

According to an example embodiment of the present invention, the sleeve-shaped sensor housing can be metallic, for example. The sleeve-shaped sensor housing can have, for example, an external thread and/or an external hexagon profile. In particular, the particle sensor can be mounted in this or in particular in a different manner in an exhaust gas line, in particular of an internal combustion engine.

According to an example embodiment of the present invention, a sensor element is fixed in the sensor housing. The sensor element is in particular at least in part fixed in the through-hole of the sensor housing. For example, it can be a ceramic sensor element, for example based on zirconium oxide and/or aluminum oxide, which can be fixed in particular by means of ceramic elements, in particular sealing elements, in the through-hole of the sensor housing.

According to an example embodiment of the present invention, the sensor element projects beyond the sensor housing on the exhaust gas side. It can be provided, for example, that a sensitive region of the sensor element, in particular a conventional interdigitated electrode structure, is arranged on the part of the sensor element projecting beyond the sensor housing on the exhaust gas side.

The particle sensor according to an example embodiment of the present invention has a sleeve-shaped protection tube that is fastened, for example welded, to the sensor housing on the exhaust gas side. For example, the protection tube can be welded to a collar of the sensor housing from the radial outside. For example, the protection tube can be metallic; for example it can be composed of a plurality of deep-drawn parts.

According to an example embodiment of the present invention, the protection tube consists of two protection sleeves, an inner protection sleeve and an outer protection sleeve. Optionally, the particle sensor can have a further protection sleeve, which in particular interacts with the protection tube and/or the inner protection sleeve and the outer protection sleeve, for example surrounds these at least in part. A plurality of further protection sleeves, in particular of this type, are of course also possible.

In particular, the inner protection sleeve and the outer protection sleeve each have the basic shape of a sleeve. In particular, there is at least one passage in each case in an axial direction of each sleeve. In particular, the inner protection sleeve and the outer protection sleeve each have, individually and/or as a whole, a rotationally symmetric basic shape. The sleeve-shaped housing, the inner protection sleeve and/or the outer protection sleeve and in particular also the sensor element can, for example, be arranged coaxially to one another with respect to their basic structure.

The inner protection sleeve is fastened, for example welded, to the sensor housing on the exhaust gas side.

According to an example embodiment of the present invention, the inner protection sleeve surrounds an exhaust-gas-side end region of the sensor element, for example an exhaust-gas-side end region of the sensor element, on which a sensitive region of the sensor element, in particular the sensitive region already explained above, is arranged.

The outer protection sleeve is fastened, for example welded, to the sensor housing on the exhaust gas side, for example together with the inner protection sleeve, by a single circumferential weld seam.

According to an example embodiment of the present invention, the outer protection sleeve surrounds the inner protection sleeve at least in some regions. In particular, at least parts of the outer protection sleeve are arranged radially and/or, on the exhaust gas side, axially outside, in particular on the opposite side, as seen from the sensor element, of the inner protection sleeve.

However, in the context of this feature according to an example embodiment of the present invention it can also be provided that the outer protection sleeve receives only a part of the inner protection sleeve that is close to the housing in its interior, while the inner protection sleeve penetrates the outer protection sleeve and protrudes axially beyond the outer protection sleeve in the exhaust gas direction.

It can also be provided that the outer protection sleeve is arranged the inner protection sleeve both radially and, on the exhaust gas side, axially outside, in particular on the side, as seen from the sensor element, opposite the sensor element, of the inner protection sleeve.

According to an example embodiment of the present invention, an annular space is formed between the outer protection sleeve and the inner protection sleeve. An annular space is understood in particular to mean an intermediate space between two, in particular concentric, sleeves, for example cylinders, arranged one inside the other. It can be, for example, a hollow cylindrical space. In particular, the projection of the annular space in the axial direction is an annular surface that is delimited in particular by two concentric circles. For example, the radii of the concentric circles may form a ratio between 0.35 and 0.7.

According to an example embodiment of the present invention, the outer protection sleeve and the inner protection sleeve each have a gas outlet and a gas inlet. In particular, a gas inlet of the outer protection sleeve and a gas inlet of the inner protection sleeve and a gas outlet of the outer protection sleeve and a gas outlet of the inner protection sleeve are provided.

Such a gas inlet or such a gas outlet of the respective protection sleeve can in particular be at least one opening in the respective protection sleeve, i.e., in each case exactly one opening or in each case a plurality of openings, the opening or the openings in particular representing a macroscopic gas passage from an outer side of the respective sleeve to an inner side of the respective sleeve. In the case of a plurality of openings, these openings, parallel to one another, provide a macroscopic gas passage from an outer side of the respective sleeve to an inner side of the respective sleeve. The openings can in principle point in any direction, for example in the axial direction or in the radial direction.

According to an example embodiment of the present invention, the gas inlet of the outer protection sleeve can consist, for example, of a plurality of openings arranged regularly along the circumference of the outer protection sleeve. The gas inlet of the inner protection sleeve can consist, for example, of a plurality of openings arranged regularly along the circumference of the inner protection sleeve. The gas outlet of the outer protection sleeve can consist, for example, of a central opening on the exhaust gas side. The gas outlet of the inner protection sleeve can consist, for example, of a central opening on the exhaust gas side or of a plurality of openings arranged on an exhaust-gas-side bottom of the inner protection sleeve, which is also referred to as a baffle plate.

Gas inlets and gas outlets are associated with flow cross sections within the scope of the present invention. In the case of a single opening, this is the geometric cross section of the opening, in the case of multiple openings, this is the sum of the geometric cross sections of the respective openings.

In particular, where there is a negative gradient of the static pressure (also: pressure gradient) in the exhaust gas pointing in the axial direction, for example where the static pressure on the exhaust-gas-side axial end of the protection tube is lower than at the axial end of the protection tube facing away from the exhaust gas, it is provided in particular that the protection tube, in particular necessarily, is subjected to a flow as follows: from the gas inlet of the outer protection sleeve into the annular space, from there through the gas inlet of the inner protection sleeve into the interior of the inner protection sleeve, and from there through the gas outlets of the outer protection sleeve and then through the gas outlet of the outer protection sleeve or first through the gas outlet of the outer protection sleeve and then through the gas outlet of the inner protection sleeve, and thereafter through the gas outlet of the inner protection sleeve. In particular in this context, the association of the openings in the protection sleeves with gas inlets and gas outlets is obtained for sensors according to the present invention.

In this case, “necessarily” is to be understood in particular to mean that a flow in a different sequence or via other paths is structurally excluded. In particular, it is provided that the annular space communicates directly with a region outside the outer protection sleeve only via the gas inlet of the outer protection sleeve and/or that the annular space communicates directly with the interior of the inner protection sleeve only via the gas inlet of the inner protection sleeve and/or that the interior of the inner protection sleeve communicates with a region outside the particle sensor through the gas outlets of the outer and inner protection sleeves without previously communicating again with the annular space.

In other words: in particular, the flow through the protection tube with respect to the gas inlets and gas outlets, i.e., apart from the parallel passage through a plurality of openings belonging to a gas inlet and to a gas outlet, takes place in particular, due to the structure of the protection tube, only in the sequence defined in this way on an in particular linear and in particular unbranched path.

If there is a negative gradient of the static pressure in the exhaust gas pointing in the axial direction, for example if the static pressure at the exhaust-gas-side axial end of the protection tube is lower than at the axial end of the protection tube facing away from the exhaust gas, the flow through the protection tube can be driven in particular by the gas outlet of the inner or outer protection sleeve being arranged on the exhaust gas side of the gas inlet of the outer protection sleeve, i.e., in particular when the particle sensor is mounted on the wall of an exhaust gas line, at a location with a lower static pressure. The flow influence of the particle sensor itself, in particular of the protection tube itself, in particular a slowing down of the flow in the region of the gas inlet of the outer protection sleeve, can also cause or increase this effect.

According to an example embodiment of the present invention, the gas inlet of the inner protection sleeve is in particular arranged at the axial height of the sensor element. In particular, the gas inlet of the inner protection sleeve can be arranged at the axial height of a sensitive region of the sensor element, in particular of the sensitive region already explained above. In cooperation with the throttling effect at the gas inlet of the inner protection tube, there is a substantial acceleration of the exhaust gas in the direction of the sensor element. For example, in the mentioned case of a particle sensor, the deposition of particles on the sensor element and thus the sensitivity of the particle sensor increase, as explained above.

### BRIEF DESCRIPTION OF THE DRAWINGS

FIG. 1 shows a cross section along the longitudinal axis of the particle sensor according to a first exemplary embodiment of the present invention.

FIG. 2 shows an exhaust-gas-side end region of the sensor element of the particle sensor from FIG. 1 in plan view.

### DETAILED DESCRIPTION OF EXAMPLE EMBODIMENTS

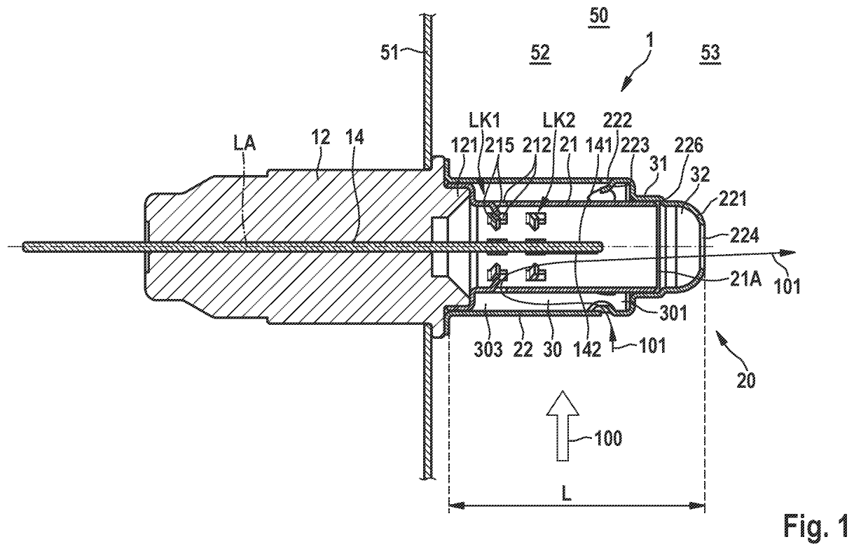

FIG. 1 shows a cross section along the longitudinal axis LA of the particle sensor 1 according to a first exemplary embodiment.

The particle sensor 1 has a sleeve-shaped sensor housing 12, in the through-hole of which a ceramic sensor element 14 is fixed. The ceramic sensor element 14 projects beyond the sensor housing 12 both on the side of the sensor housing 12 facing the exhaust gas (on the right in FIG. 1) and on the side of the sensor housing 12 facing away from the exhaust gas (left in FIG. 1).

A sleeve-shaped metallic protection tube 20 is welded to a circumferential collar 121 of the sensor housing 12 pointing in the exhaust gas direction. The protection tube 20 consists of an inner protection sleeve 21 and an outer protection sleeve 22. The inner protection sleeve 21 surrounds an exhaust-gas-side end region 141 of the sensor element 14 at a radial and axial distance.

The outer protection sleeve 22 surrounds the inner protection sleeve 21 in such a way that it rests against the inner protection tube 21 at the axial height of the collar 121 and is welded together with said inner protection tube on the collar 121 by means of a circumferential weld seam, that furthermore an annular space 30 is formed on the exhaust gas side of the collar 121 between the outer protection sleeve 22 and the inner protection sleeve 21, that furthermore a contact region 31 is formed on the exhaust gas side of the annular space 30, in which contact region the inner protection sleeve 21 is in full contact with its outer surface on the inner surface of the outer protection sleeve 22, and that furthermore a front space 32 is formed on the exhaust gas side of the contact region 31, which front space is radially delimited by the outer protection sleeve 22 and delimited by a bottom 221 of the outer protection sleeve 22 on the side facing the exhaust gas.

The outer protection sleeve 22 has, for example, eight gas inlet openings 222 arranged at equal distances along the circumference of the outer protection sleeve 22 at an axial height of an end region 301 of the annular space 30 facing the exhaust gas. In the example, the gas inlet openings 222 each have a swirl element 223 designed as a swirl flap that imparts a pulse in the direction of the sensor housing 12 to the gas flowing into the annular space 30 and a rotational pulse in the direction of the longitudinal axis LA of the sensor so that the exhaust gas in the annular space 30 rotates around the inner protection sleeve 21.

In one variant of this embodiment, swirl elements 223 can be dispensed with.

The outer protection sleeve 22 also has a relatively large gas outlet opening 224 on the bottom 221. In one variant, the gas outlet opening 224 can even be enlarged in such a way that the bottom 221 is completely or largely omitted.

The inner protection sleeve 21 has, for example, two rings of holes L1, L2 spaced apart from one another in the longitudinal direction LA, each having eight gas inlet openings 212 arranged at equal distances along the circumference of the inner protection sleeve 21 on the housing side at the axial height of a region 303 of the annular space 30, which region is on the housing side in the axial direction. The gas inlet openings 212 are furthermore arranged at the axial height of the sensor element 14.

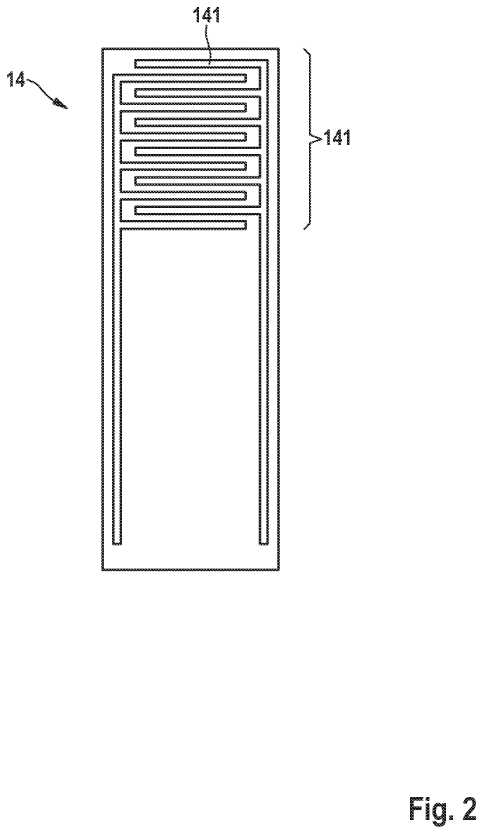

More precisely, the gas inlet openings 212 are arranged on the housing side of a sensitive region of the sensor element 14. The sensitive region of sensor element 14 is, for example, an interdigitated electrode structure 142 (see also FIG. 2).

For example, it is further provided that the gas inlet openings 212 are rectangular and each have a rectangular deflection element 215, which is in particular designed in the form of a strip pressed into the sensor housing 12 and which deflects an exhaust gas entering the annular space 30 toward the gas outlet 21A of the inner protection sleeve 21. Alternatively, it is also possible that a deflection element 215 is assigned to the gas inlet opening 212 that has a different shape, in particular the shape of the swirl flap, and which deflects an exhaust gas entering the annular space 30 toward the gas outlet 21A of the inner protection sleeve 21.

In this example, the gas inlet openings 212 of the inner protection sleeve 21 are arranged on the axial side of the sensitive region of the sensor element 14 facing away from the exhaust gas. Thus, the exhaust gas flowing into the interior of the inner protection sleeve 21 is directed by the deflection elements 215 to the sensitive region of the sensor element 14.

A plan view of the sensor element 14 in perspective from bottom to top in FIG. 1 is as shown in FIG. 2. The sensor element 14 is planar and an interdigitated electrode structure 142 is arranged on the surface of the sensor element 14 in an exhaust-gas-side end region 141, which interdigitated electrode structure forms the sensitive region of the sensor element 14.

In one alternative, a cylindrical sensor element 14 can also be used.

The particle sensor 1 can thus be mounted in the wall 51 of an exhaust gas line 50 of an internal combustion engine in such a way that, as seen in a cross section of the exhaust gas line 50, the gas inlet of the outer protection sleeve 22 is arranged in an edge region 52 of the exhaust gas line, while the gas outlet of the outer protection sleeve 22 is arranged in a central region 53 of the exhaust gas line; see FIG. 5. Exhaust gas flows through the exhaust gas line 50 substantially perpendicularly to the longitudinal axis LA of the particle sensor 1, parallel to the drawing plane of FIG. 5, in the direction of the double arrow 100. Because the flow rate in the exhaust gas line 50 in the central region 53 of the exhaust gas line is higher than in the edge region 52 of the exhaust gas line, the static pressure at the gas outlet opening 224 of the outer protection sleeve 22 is lower than at the gas inlet openings 222 of the outer protection sleeve 22. As a result, exhaust gas flows through the gas inlet openings 222 of the outer protection sleeve 22 into the annular space 30, from there through the gas inlet openings 212 of the inner protection sleeve 21 into the interior of the inner protection sleeve 21, where it interacts with the sensitive region of the sensor element 14. Subsequently, the exhaust gas passes through the gas outlet openings 213 of the inner protection sleeve 21 into the front space 32 and from there through the gas outlet opening 224 of the outer protection sleeve 22. This through-flow is indicated by the arrow line 101 in FIG. 5.

What is claimed is:

1. A particle sensor for determining concentration of soot in exhaust gas of an internal combustion engine, the particle sensor comprising:
a sleeve-shaped sensor housing;
a sensor element fixed in the sensor housing, the sensor element projecting beyond the sensor housing on an exhaust gas side of the particle sensor; and
a sleeve-shaped protection tube which is fastened to the sensor housing on the exhaust gas side, the protection tube including an inner protection sleeve and an outer protection sleeve, the inner protection sleeve surrounding an exhaust-gas-side end region of the sensor element, the outer protection sleeve surrounding the inner protection sleeve at least in some regions, so that an annular space is formed between the outer protection sleeve and inner protection sleeve, the outer protection sleeve and the inner protection sleeve each having a gas outlet and a gas inlet, and a flow occurring through the protection tube from the gas inlet of the outer protection sleeve into the annular space, from the annular space through the gas inlet of the inner protection sleeve into an interior of the inner protection sleeve and from the interior of the inner protection sleeve through the gas outlets of the outer and inner protection sleeves, the gas inlet of the inner protection sleeve including a plurality of gas inlet openings arranged on at least two rings of holes spaced apart from each other in a longitudinal direction and extending in a circumferential direction, each gas inlet opening of the plurality of gas inlet openings individually being associated with a deflection element that deflects an exhaust gas, which enters the annular space through the gas inlet opening, in a direction of the gas outlet of the inner protection sleeve.

2. The particle sensor according to claim 1, wherein the gas inlet of the outer protection sleeve has at least one gas inlet opening provided with at least one swirl element that deflects exhaust gas entering the annular space such that it rotates around the inner protection sleeve within the annular space.

3. The particle sensor according to claim 1, wherein a sensitive region is arranged on the sensor element.

4. The particle sensor according to claim 3, wherein the sensitive region of the sensor element is an interdigitated electrode structure.

5. The particle sensor according to claim 1, wherein the at least two rings of holes include a first ring of holes and a second ring of holes, and in that the gas inlet openings of the first ring of holes are arranged centrally between the gas inlet openings of the second ring of holes, as seen in the circumferential direction.

6. The particle sensor according to claim 1, wherein a distance in the longitudinal direction between the at least two rings of holes is 3 mm to 6 mm.

7. The particle sensor according to claim 1, wherein a total length of the protection tube is not more than 21 mm.

8. The particle sensor according to claim 1, wherein the particle sensor is in an exhaust gas line of the internal combustion engine, wherein a cross section of the exhaust gas line has a more central region and a more peripheral region that surrounds the more central region, a flow rate of the exhaust gas in the exhaust gas line in the more central region is higher than in the more peripheral region, and the gas inlet of the outer protection sleeve being arranged in the more peripheral region, and the gas outlet of the inner or outer protection sleeve being arranged in the more central region.
